(19) United States
(12) Patent Application Publication
(10) Pub. No.: US 2018/0329220 A1
(43) Pub. Date: Nov. 15, 2018

(54) 3D DISPLAY DEVICE AND METHOD FOR MANUFACTURING THE SAME

(71) Applicants: BOE Technology Group Co., Ltd., Beijing (CN); Hefei Xinsheng Optoelectronics Technology Co., Ltd., Anhui (CN)

(72) Inventors: Weijie Ma, Beijing (CN); Xianlin Ding, Beijing (CN); Taofeng Xie, Beijing (CN); Pingping Jia, Beijing (CN); Yi Zhang, Beijing (CN); Cui Chen, Beijing (CN)

(21) Appl. No.: 15/773,782

(22) PCT Filed: Jul. 11, 2017
(86) PCT No.: PCT/CN2017/092477

§ 371 Date: May 4, 2018

(30) Foreign Application Priority Data
Sep. 12, 2016 (CN) 201610819417.X

(51) Int. Cl. G02B 27/22; G02F 1/1343; G02F 1/1333

(52) U.S. Cl. CPC G02B 27/2214; G02F 1/134309; G02F 2201/121; G02F 1/13439; G02F 2201/30; G02F 1/13338

(57) ABSTRACT

A 3D display device and a method for manufacturing a 3D display device. The 3D display device includes: a display component; and a liquid crystal grating on a light exit side of the display component. The liquid crystal grating includes: a substrate; a liquid crystal layer between the substrate and the display component; and a 3D display control component located only on a side of the substrate facing the liquid crystal layer and located only on one side of the liquid crystal layer.

### CROSS-REFERENCE TO RELATED APPLICATION

This application is a Section 371 National Stage Application of International Application No. PCT/CN2017/092477, filed on Jul. 11, 2017, entitled “3D DISPLAY DEVICE AND METHOD FOR MANUFACTURING THE SAME”, which claims priority to Chinese Patent Application No. 201610819417.X filed on Sep. 12, 2016 with SIPO, incorporated herein by reference in entirety.

### BACKGROUND

### Technical Field

Embodiments of the present disclosure relate to the field of display technology, and in particular, to a 3D display device and a method for manufacturing a 3D display device.

### Description of the Related Art

With the continuous development of liquid crystal display technology, three-dimensional (3D) stereoscopic display technology has attracted much attention and has become a frontier technology field in the display field. The 3D stereoscopic display technology includes a vision-assisted 3D display and a naked-eye 3D display. Among them, the naked-eye 3D display is a display that does not require any vision-assisted devices to watch a 3D effect. In the naked-eye 3D display technology, a 3D display device based on a liquid crystal grating has attracted attention because of advantages, such as simple structure, compatibility with liquid crystal processes, good performance and the like. The 3D display device based on the liquid crystal grating usually achieves a 3D stereoscopic display effect based on a binocular parallax principle and a grating spectroscopy principle.

The 3D display device in the relevant art has a relatively large thickness, and the process for manufacturing it is relatively complicated.

### SUMMARY

The embodiments of the present disclosure are intended to provide a 3D display device and a method for manufacturing the same to at least partially reduce the thickness of the 3D display device and simplify the manufacturing process.

An embodiment of the present disclosure provides a 3D display device, comprising:

a display component; and

a liquid crystal grating on a light exit side of the display component,

wherein the liquid crystal grating comprises:
a substrate;
a liquid crystal layer between the substrate and the display component; and
a 3D display control component located only on a side of the substrate facing the liquid crystal layer and located only on one side of the liquid crystal layer.

Optionally, the 3D display control component comprises:

a common electrode; and

a plurality of strip-shaped slit electrodes between the common electrode and the liquid crystal layer, the slit electrodes being parallel to each other and spaced away from each other by a set distance.

Optionally, the plurality of slit electrodes are in regions of the liquid crystal grating for forming dark stripes; or

the plurality of slit electrodes are in regions of the liquid crystal grating for forming bright stripes.

Optionally, the 3D display control component comprises a plurality of electrode groups arranged in parallel to each other and spaced away from each other by a set distance,

wherein each of the electrode groups comprises a first strip-shaped electrode and a second strip-shaped electrode arranged in parallel to each other, having opposite polarities to each other and having a same arrangement direction as the plurality of electrode groups.

Optionally, the electrode groups are in regions of the liquid crystal grating for forming dark stripes; or

the electrode groups are in regions of the liquid crystal grating for forming bright stripes.

Optionally, the liquid crystal grating further comprises a touch detection component between the substrate and the 3D display control component or between the 3D display control component and the liquid crystal layer.

Optionally, the touch detection component comprises a touch electrode layer in a form of metal mesh structure.

Optionally, the liquid crystal grating comprises only one substrate.

Optionally, the display component comprises a first polarizer on the light exit side of the display component, and the liquid crystal grating comprises a second polarizer on a side of the substrate facing away from the liquid crystal layer.

Optionally, the touch electrode layer comprises:

a plurality of first metal electrodes extending in a first direction;

a plurality of second metal electrodes extending in a second direction; and

bridging portions located at overlapping portions of the first metal electrodes and the second metal electrodes in such a way that the first metal electrodes are insulated from the second metal electrodes.

An embodiment of the present disclosure provides a method for manufacturing a 3D display device, comprising:

forming a display component; and

forming a liquid crystal grating on a light exit side of the display component,

wherein the forming the liquid crystal grating on the light exit side of the display component comprises:
forming a 3D display control component only on a substrate; and
positioning the 3D display control component to face the light exit side of the display component, and forming a liquid crystal layer between the substrate on which the 3D display control component is formed and the display component in such a way that the 3D display control component is located only on one side of the liquid crystal layer.

Optionally, the forming the 3D display control component comprises:

forming a common electrode; and

forming a plurality of strip-shaped slit electrodes on the common electrode, the slit electrodes being parallel to each other and spaced away from each other by a set distance.

Optionally, the forming the slit electrodes comprises forming the slit electrodes in regions of the liquid crystal grating for forming dark stripes or in regions of the liquid crystal grating for forming bright stripes.

Optionally, the forming the 3D display control component comprises:

forming a plurality of electrode groups arranged in parallel to each other and spaced away from each other by a set distance,

wherein each of the electrode groups comprises a first strip-shaped electrode and a second strip-shaped electrode arranged in parallel to each other, having opposite polarities to each other and having a same arrangement direction as the plurality of electrode groups.

Optionally, the forming the electrode groups comprises forming electrode groups in regions of the liquid crystal grating for forming dark stripes or in regions of the liquid crystal grating for forming bright stripes.

Optionally, the forming the liquid crystal grating on the light exit side of the display component further comprises:

forming a touch detection component between the substrate and the 3D display control component or between the 3D display control component and the liquid crystal layer.

Optionally, the forming the touch detection component comprises forming a touch electrode layer in a form of metal mesh structure.

### BRIEF DESCRIPTION OF THE DRAWINGS

FIG. 1 is a schematic structural view of a 3D display device in the relevant art;

FIG. 2 is a schematic structural view of a strip-shaped electrode located at an inner side of a first substrate in the relevant art;

FIG. 3 is a schematic structural view of a 3D display device according to an embodiment of the present disclosure;

FIG. 4 is a schematic structural view of a 3D display control component in the 3D display device according to the embodiment shown in FIG. 3;

FIG. 5 is a schematic structural view of a touch electrode layer in the 3D display device according to the embodiment shown in FIG. 3;

FIG. 6 is a schematic structural view of a 3D display device according to an embodiment of the present disclosure;

FIG. 7 is a schematic structural view of a 3D display control component in the 3D display device according to the embodiment shown in FIG. 6;

FIG. 8 is a schematic structural view of a 3D display device according to an embodiment of the present disclosure;

FIG. 9 is a schematic structural view of a 3D display control component in the 3D display device according to the embodiment shown in FIG. 8;

FIG. 10 is a schematic structural view of a 3D display device according to an embodiment of the present disclosure;

FIG. 11 is a schematic structural view of a 3D display control component in the 3D display device according to the embodiment shown in FIG. 10; and

FIGS. 12(a) to 12 (g) are flow diagrams illustrating a manufacturing process of a 3D display device according to an embodiment of the present disclosure.

### DETAILED DESCRIPTION OF PREFERRED EMBODIMENTS

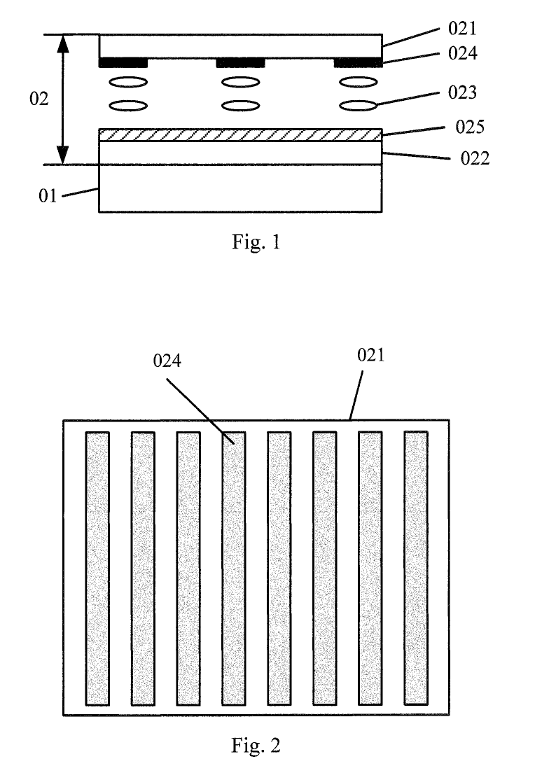

Referring to FIG. 1, the 3D display device includes a display component 01 and a liquid crystal grating 02 (shown by a double-headed arrow in FIG. 1) disposed on a light exit side of the display component 01. The liquid crystal grating 02 includes a first substrate 021 and a second substrate 022, a liquid crystal layer 023 charged between the first substrate 021 and the second substrate 022, strip-shaped electrodes 024 arranged on a side of the first substrate 021 facing the liquid crystal layer 023 in parallel to each other and spaced away from each other by a set distance, and a surface electrode 025 on a side of the second substrate 022 facing the liquid crystal layer 023. The schematic structural view of the strip-shaped electrodes 024 on the inner side of the first substrate 021 may be shown in FIG. 2. In the 3D display device described above, the liquid crystal grating is a twisted nematic (TN) type liquid crystal grating. Since the liquid crystal grating on the light exit side of the display component in the above 3D display device uses two substrates, the above 3D display device has a relatively large thickness. Moreover, 3D display control components for achieving a 3D display function in the liquid crystal grating on the light exit side of the display component in the above 3D display device is distributed on both sides of the liquid crystal layer. Thus, when the liquid crystal grating is manufactured, it is necessary to respectively manufacture 3D display control components for achieving the 3D display function on two substrates, thereby incurring complicated manufacturing processes.

Herein, “display control component(s)” or “3D display control component(s)” may include at least two electrodes which generate an electric field for deflecting liquid crystal molecules, for example, the two electrodes may include a common electrode and at least one slit electrode.

The embodiments of the present disclosure provide a 3D display device and a method for manufacturing the same, to reduce the thickness of the 3D display device and simplify the manufacturing process.

The technical solutions in the embodiments of the present disclosure will be clearly and completely described below with reference to the accompanying drawings in the embodiments of the present disclosure. Apparently, the described embodiments are merely a part of but not all of the embodiments of the present disclosure. All other embodiments obtained by those skilled in the art based on the embodiments of the present disclosure without any creative efforts shall fall within the scope of the present disclosure.

It should be noted that, the thickness and shape of each layer in the drawings of the present disclosure do not reflect the true scale, and the purpose is only to illustrate the content of the present disclosure.

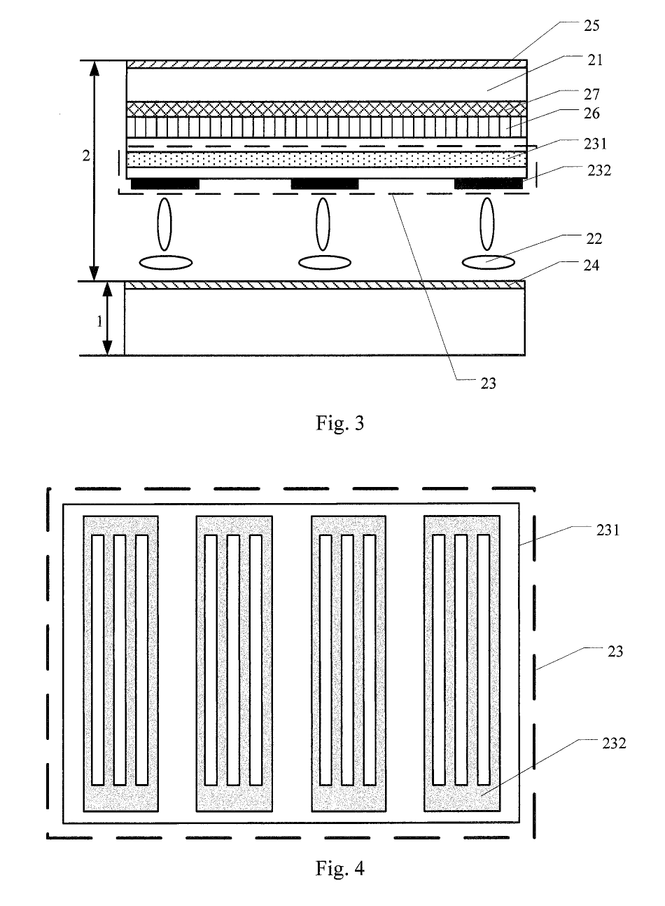

Referring to FIG. 3, a 3D display device according to an embodiment of the present disclosure includes: a display component 1 (shown by a lower double-headed arrow in FIG. 3); and a liquid crystal grating 2 (shown by an upper double-headed arrow in FIG. 3) disposed on a light exit side of the display component 1. The liquid crystal grating 2 includes a substrate 21, a liquid crystal layer 22 between the substrate 21 and the display component 1, and a 3D display control component 23 (shown by a dashed box in FIG. 3) located only on a side of the substrate 21 facing the liquid crystal layer 22. The 3D display control component 23 is only located on one side of the liquid crystal layer 22, that is to say, there is no 3D display control components on the other side of the liquid crystal layer 22.

The display component 1 may be a liquid crystal display (LCD), an organic light emitting display (OLED), a plasma display panel (PDP), or a cathode ray display (CRT), but the embodiments of the present disclosure are not limited thereto.

Since only one substrate 21 is used for the liquid crystal grating 2 in the above-described 3D display device, the thickness of the 3D display device can be reduced. Moreover, the 3D display control component 23 is located only on the side of the substrate 21 facing the liquid crystal layer 22, thus when manufacturing the liquid crystal grating 2, the 3D display control component 23 for achieving the 3D display function only needs to be manufactured on one substrate 21, therefore the manufacturing process can be simplified.

Optionally, the display component 1 includes a first polarizer 24 disposed on the light exit side of the display component 1. The liquid crystal grating 2 may further include a second polarizer 25 located on a side of the substrate 21 facing away from the liquid crystal layer 22, as shown in FIG. 3.

Certainly, the display component 1 may not include the first polarizer disposed on the light exit side of the display component 1. At this time, the liquid crystal grating 2 may further include: a first polarizer between the liquid crystal layer 22 and the display component 1 and a second polarizer on the substrate 21 facing away from the liquid crystal layer 22.

A direction of the light transmission axis of the first polarizer is perpendicular to or parallel to a direction of the light transmission axis of the second polarizer.

Optionally, as shown in FIG. 4, the 3D display control component 23 (shown by a dashed box in FIG. 4) includes: a common electrode 231; and a plurality of strip-shaped slit electrodes 232 between the common electrode 231 and the liquid crystal layer 22, the slit electrodes being parallel to each other and spaced away from each other by a set distance. The slit electrodes 232 are in a region of the liquid crystal grating 2 for forming a dark stripe. The common electrode 231 is insulated from the slit electrodes 232. For example, an insulating layer may be disposed between the common electrode 231 and the slit electrodes 232 so that the common electrode 231 is insulated from the slit electrodes 232.

The common electrode 231 may be a plate-shaped electrode or a slit-shaped electrode, which is not limited in the embodiments of the present disclosure. The set distance may be given according to actual needs.

The liquid crystal grating herein may be referred to as an ADS (Advanced Super Dimension Switch) type liquid crystal grating, and the liquid crystal grating is a normally bright type liquid crystal grating. When the liquid crystal grating is in a 3D working state, an electric field generated by edges of the slit electrodes in the same plane and an electric field generated between the common electrode and the slit electrodes form a multidimensional electric field. The multidimensional electric field can cause liquid crystal molecules that face the slit electrodes to rotate, so that the light cannot be transmitted, thereby dark stripes are formed in a region corresponding to the region where the slit electrode is located, while in the region between adjacent slit electrodes, the corresponding liquid crystal molecules do not rotate, so that bright stripes are formed in the region corresponding to the region between the adjacent slit electrodes, i.e., alternately bright and dark grating stripes can be formed. When a 3D display signal is inputted, the 3D display effect can be achieved.

Optionally, when the liquid crystal grating is a normally bright type liquid crystal grating, a 3D/2D conversion function may also be set. For example, a control switch may be provided. When the liquid crystal grating is in a 3D working state, a working voltage is applied to the common electrode and the slit electrodes for forming alternately bright and dark grating stripes. When a 3D display signal is inputted, the 3D display effect can be achieved. When the liquid crystal grating is in a 2D working state, the common electrode and slit electrodes are not loaded with the working voltage, so that the liquid crystal molecules do not rotate, thereby not forming the alternately bright and dark grating stripes. In this case, the liquid crystal grating is equivalent to a piece of transparent glass. When a 2D display signal is inputted, the 2D display effect can be achieved.

It should be noted that, a distance between adjacent slit electrodes 232 is equal to a width of pixels of at least two display components, in other words, a dark stripe and a bright stripe adjacent to each other cover at least the pixels of two rows of display components.

Optionally, in order to achieve the touch function, the liquid crystal grating 2 may further include a touch detection component 26. The touch detection component 26 may be located between the substrate 21 and the 3D display control component 23 (as shown in FIG. 3). Certainly, the touch detection component 26 may also be located between the 3D display control component 23 and the liquid crystal layer 22. The embodiments of the present disclosure are not limited thereto.

It should be noted that, if the touch detection component 26 is located between the substrate 21 and the 3D display control component 23, then it is closer to the light exit side substrate of the 3D display device, resulting in higher touch sensitivity.

The touch detection component 26 is insulated from the 3D display control component 23. For example, an insulating layer may be disposed between the touch detection component 26 and the 3D display control component 23, so that the touch detection component 26 is insulated from the 3D display control component 23.

Optionally, in order to reduce an induction capacitance between the touch electrode and the 3D display electrode and reduce the interference, the touch detection component 26 may include a touch electrode layer in a form of metal mesh structure.

The touch electrode layer is a touch electrode layer in the form of metal mesh structure. On the one hand, the electrode in the touch electrode layer in the form of metal mesh structure is a metal electrode, the resistance is low, and an area occupied by the metal mesh structure is small, therefore the induction capacitance between the touch electrode and the 3D display electrode (that is, the electrode in the 3D display control component) can be reduced, thereby reducing the interference; on the other hand, the cost of the metal mesh touch electrode is lower than that of indium tin oxide (ITO), therefore the production cost can be reduced.

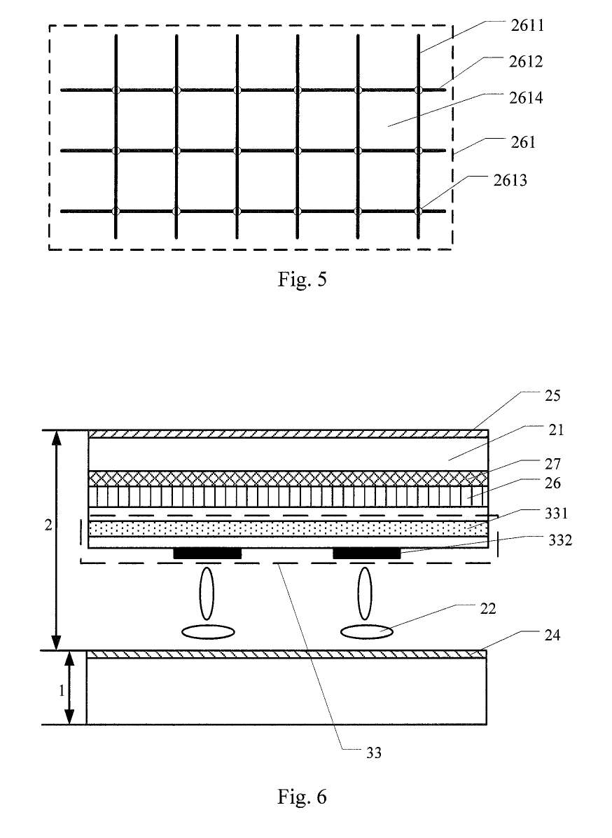

Optionally, as shown in FIG. 5, the touch electrode layer 261 (shown by a dashed box in FIG. 5) includes a plurality of first metal electrodes 2611 extending in a first direction, a plurality of second metal electrodes 2612 extending in a second direction, and bridging portions 2613. The bridging portions 2613 are located at overlapping portions of the first metal electrode 2611 and the second metal electrode 2612, such that the first metal electrode 2611 is insulated from the second metal electrode 2612. Any two adjacent first metal electrodes 2611 and any two adjacent second metal electrodes 2612 together define a mesh cell 2614. The first direction is not parallel to (for example, perpendicular to) the second direction.

Optionally, in order to avoid degrading aperture ratio of display, the metal touch electrodes (i.e., the first metal electrodes and the second metal electrodes) may be disposed at positions corresponding to gaps between adjacent pixels of the display component, i.e. the pixels of the display component are set at positions corresponding to the mesh cells.

Optionally, in order to reduce the influence of the metal touch electrode on the 3D display effect as much as possible, the metal touch electrode having the same extension direction as the slit electrode 232 or having extension direction similar to the extension direction of the slit electrode 232 may be disposed in a region of the liquid crystal grating 2 for forming a dark stripe.

Optionally, in order to prevent the metal touch electrode from reflecting external light and thereby affecting the display effect, the liquid crystal grating 2 may further include a black matrix layer 27 between the substrate 21 and the touch electrode layer in the form of metal mesh structure for defining the pixel of each display component.

Since the black matrix layer 27 is disposed between the substrate 21 and the touch electrode layer 261 in the form of metal mesh structure and used to define each pixel, and the pixel is disposed at a position corresponding to the mesh cell, it can be seen that the metal touch electrode is disposed on a corresponding position of the black matrix layer 27, so as to prevent the metal touch electrode from reflecting external light and thereby affecting the display effect.

Referring to FIG. 6, FIG. 6 shows a 3D display device according to an embodiment of the present disclosure, which is similar to the 3D display device according to the embodiment shown in FIG. 3. The same parts will not be further described herein, only different parts are described below.

Referring to FIG. 6, in the 3D display device according to an embodiment of the present disclosure, the liquid crystal grating 2 includes a substrate 21, a liquid crystal layer 22 between the substrate 21 and the display component 1, and a 3D display control component 33 (shown by a dashed box in FIG. 6) only on a side of the substrate 21 facing the liquid crystal layer 22.

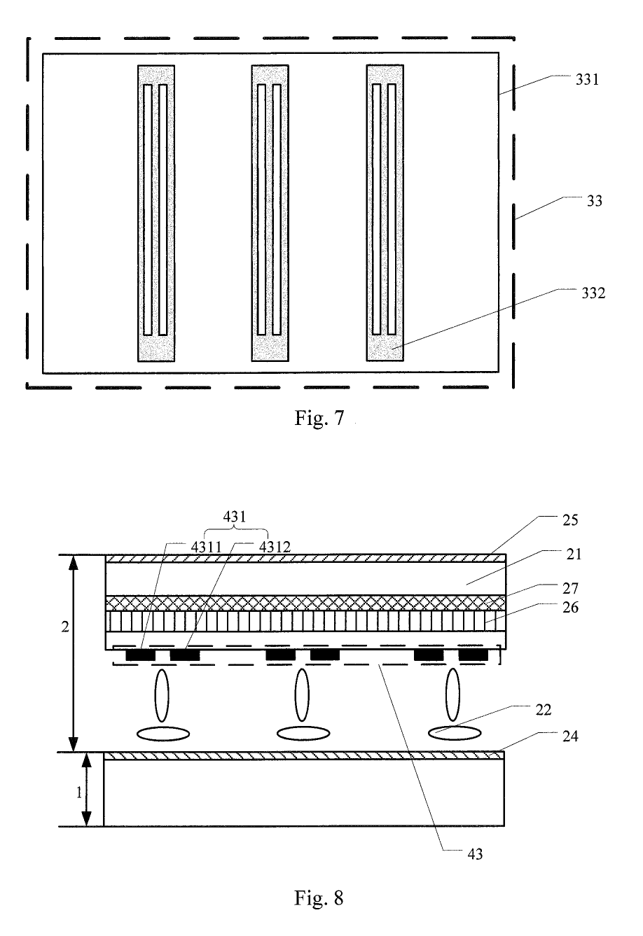

Optionally, as shown in FIG. 7, the 3D display control component 33 (shown by a dashed box in FIG. 7) includes: a common electrode 331; and a plurality of strip-shaped slit electrodes 332 between the common electrode 331 and the liquid crystal layer 22, the slit electrodes being parallel to each other and spaced away from each other by a set distance. The slit electrodes 332 are in a region of the liquid crystal grating 2 for forming a bright stripe.

The liquid crystal grating herein may be referred to as an ADS type liquid crystal grating, and the liquid crystal grating is a normally dark type liquid crystal grating. When the liquid crystal grating is in a 3D working state, an electric field generated by edges of the slit electrodes in the same plane and an electric field generated between the common electrode and the slit electrodes form a multidimensional electric field. The multidimensional electric field can cause liquid crystal molecules that face the slit electrodes to rotate, so that the light can be transmitted through these liquid crystal molecules, thereby bright stripes are formed in a region corresponding to the region where the slit electrode is located, while in the region between adjacent slit electrodes, the corresponding liquid crystal molecules do not rotate, so that dark stripes are formed in the region corresponding to the region between the adjacent slit electrodes, i.e., alternately bright and dark grating stripes can be formed. When a 3D display signal is inputted, the 3D display effect can be achieved.

It should be noted that when the liquid crystal grating is a normally dark liquid crystal grating, only the 3D display effect can be achieved, but the 2D display effect cannot be achieved, that is, the 3D/2D conversion function cannot be provided.

It should be noted that, a distance between adjacent slit electrodes 332 is equal to a width of pixels of at least two display components, in other words, a combination of a dark stripe and a bright stripe adjacent to each other covers at least the pixels of two rows of display components.

Referring to FIG. 8, FIG. 8 shows a 3D display device according to an embodiment of the present disclosure, which is similar to the 3D display device according to the embodiment shown in FIG. 3. The same parts will not be further described herein, only different parts are described below.

As shown in FIG. 8, in the 3D display device according to an embodiment of the present disclosure, the liquid crystal grating 2 includes a substrate 21, a liquid crystal layer 22 between the substrate 21 and the display component 1, and a 3D display control component 43 (shown by a dashed box in FIG. 8) located only on a side of the substrate 21 facing the liquid crystal layer 22.

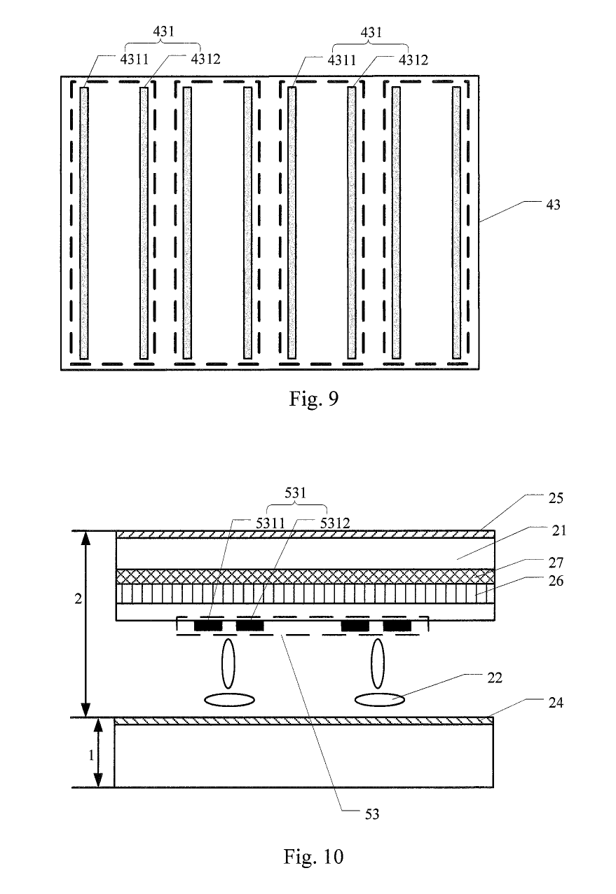

Optionally, as shown in FIG. 9, the 3D display control component 43 includes a plurality of electrode groups 431 (shown by a dashed box in FIG. 9) arranged in parallel to each other and spaced away from each other by a set distance. Each of the electrode groups 431 includes one first strip-shaped electrode 4311 and one second strip-shaped electrode 4312 arranged in parallel to each other, having opposite polarities to each other and having the same arrangement direction as the plurality of electrode groups 431. The electrode group 431 is located in a region of the liquid crystal grating 2 for forming a dark stripe. The set distance can be given according to actual requirements.

The liquid crystal grating herein may be referred to as an In-Plane Switching (IPS) type liquid crystal grating, and the liquid crystal grating is a normally bright type liquid crystal grating. When the liquid crystal grating is in a 3D working state, a planar electric field is formed between the first strip-shaped electrode 4311 and the second strip-shaped electrode 4312 of the electrode group 431 in the same plane. The planar electric field may enable liquid crystal molecules that face the electrode group 431 to rotate, so that the light cannot be transmitted, thereby dark stripes are formed in a region corresponding to the region where the electrode group 431 is located, while in the region between adjacent electrode groups 431, the corresponding liquid crystal molecules do not rotate, so that bright stripes are formed in the region corresponding to the region between the adjacent electrode groups 431, i.e., alternately bright and dark grating stripes can be formed. When a 3D display signal is inputted, the 3D display effect can be achieved.

Optionally, when the liquid crystal grating is a normally bright type liquid crystal grating, a 3D/2D conversion function may also be set. For example, a control switch may be provided. When the liquid crystal grating is in a 3D working state, a working voltage is applied to the electrode group 431 for forming alternately bright and dark grating stripes. When a 3D display signal is inputted, the 3D display effect can be achieved. When the liquid crystal grating is in a 2D working state, the electrode group 431 is not loaded with the working voltage, so that the liquid crystal molecules do not rotate, thereby not forming the alternately bright and dark grating stripes. In this case, the liquid crystal grating is equivalent to a piece of transparent glass. When a 2D display signal is inputted, the 2D display effect can be achieved. It should be noted that, a distance between adjacent electrode groups 431 is equal to a width of pixels of at least two display components, in other words, a combination of a dark stripe and a bright stripe adjacent to each other covers at least the pixels of two rows of display components.

Referring to FIG. 10, FIG. 10 shows a 3D display device according to an embodiment of the present disclosure, which is similar to the 3D display device according to the embodiment shown in FIG. 8. The same parts will not be further described herein, only different parts are described below.

As shown in FIG. 10, in the 3D display device according to an embodiment of the present disclosure, the liquid crystal grating 2 includes a substrate 21, a liquid crystal layer 22 between the substrate 21 and the display component 1, and a 3D display control component 53 (shown by a dashed box in FIG. 10) located only on a side of the substrate 21 facing the liquid crystal layer 22.

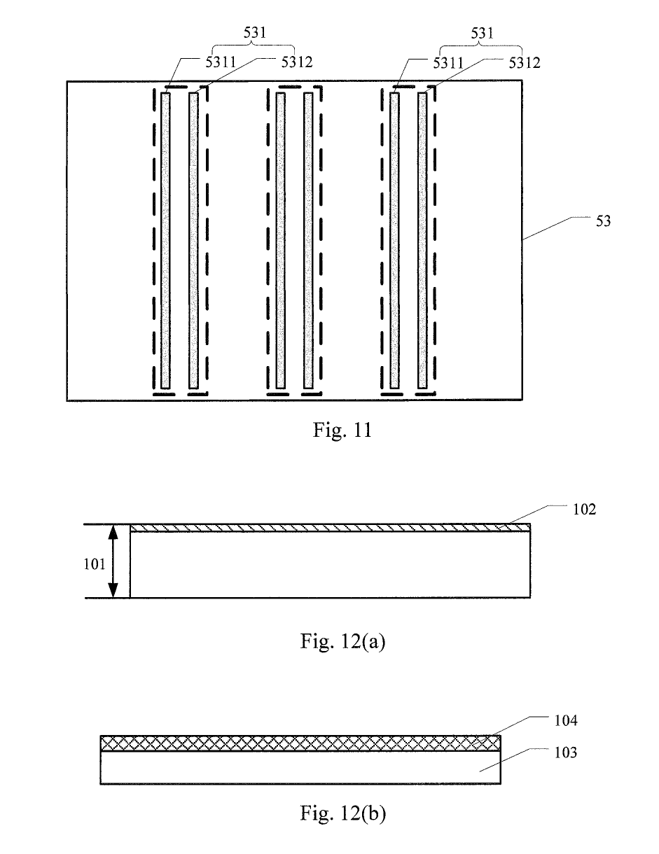

Optionally, as shown in FIG. 11, the 3D display control component 53 includes a plurality of electrode groups 531 (shown by a dashed box in FIG. 11) arranged in parallel to each other and spaced away from each other by a set distance. Each of the electrode groups 531 includes one first strip-shaped electrode 5311 and one second strip-shaped electrode 5312 arranged in parallel to each other, having opposite polarities to each other and having the same arrangement direction as the plurality of electrode groups 531. The electrode group 531 is located in a region of the liquid crystal grating 2 for forming a bright stripe.

The liquid crystal grating herein may be referred to as an In-Plane Switching (IPS) type liquid crystal grating, and the liquid crystal grating is a normally dark type liquid crystal grating. When the liquid crystal grating is in a 3D working state, a planar electric field is formed between the first strip-shaped electrode 5311 and the second strip-shaped electrode 5312 of the electrode group 531 in the same plane. The planar electric field may enable liquid crystal molecules that face the electrode group 531 to rotate, so that the light can be transmitted through these liquid crystal molecules, thereby bright stripes are formed in a region corresponding to the region where the electrode group 531 is located, while in the region between adjacent electrode groups 531, the corresponding liquid crystal molecules do not rotate, so that dark stripes are formed in the region corresponding to the region between the adjacent electrode groups 531, i.e., alternately bright and dark grating stripes can be formed. When a 3D display signal is inputted, the 3D display effect can be achieved.

It should be noted that, a distance between adjacent electrode groups 531 is equal to a width of pixels of at least two display components, in other words, a combination of a dark stripe and a bright stripe adjacent to each other covers at least the pixels of two rows of display components.

Based on the same inventive concept, an embodiment of the present disclosure further provides a method for manufacturing a 3D display device, including: forming a display component; and forming a liquid crystal grating on a light exit side of the display component.

The forming the liquid crystal grating on the light exit side of the display component includes: forming a 3D display control component only on a substrate; and positioning the 3D display control component of the substrate on which the 3D display control component is formed to face the light exit side of the display component, and forming a liquid crystal layer between the substrate on which the 3D display control component is formed and the display component.

The method for forming the display component is the same as the relevant art, which will not be repeatedly described here.

It should be noted that, the above step of forming the display component and the above step of forming the 3D display control component may be performed at the same time, or one of them is performed first, which is not limited in the embodiments of the present disclosure.

The 3D display device manufactured by the method includes a display component and a liquid crystal grating disposed on a light exit side of the display component. The liquid crystal grating includes a substrate, a liquid crystal layer between the substrate and the display component, and a 3D display control component located only on a side of the substrate facing the liquid crystal layer. Since only one substrate is used for the liquid crystal grating in the 3D display device, the thickness of the 3D display device can be reduced. Moreover, the 3D display control component is located only on the side of the substrate facing the liquid crystal layer, thus when manufacturing the liquid crystal grating, the 3D display control component for achieving the 3D display function only needs to be manufactured on one substrate, therefore the manufacturing process can be simplified.

Optionally, if the manufactured display component includes a first polarizer disposed on a light exit side of the display component, the forming the liquid crystal grating on the light exit side of the display component further includes: forming a second polarizer on a side of the substrate facing away from the liquid crystal layer.

The step of forming the second polarizer may be performed before or after the step of forming the 3D display control component only on the substrate, which is not limited in the embodiments of the present disclosure.

Certainly, if the manufactured display component does not include the first polarizer on the light exit side of the display component, the forming the liquid crystal grating on the light exit side of the display component further includes:

before positioning the 3D display control component of the substrate on which the 3D display control component is formed to face the light exit side of the display component, forming a first polarizer on the light exit side of the display component.

forming a second polarizer on a side of the substrate facing away from the liquid crystal layer.

Optionally, the forming the 3D display control component may include:

forming a common electrode; and

forming a plurality of strip-shaped slit electrodes on the common electrode, the slit electrodes being parallel to each other and spaced away from each other by a set distance.

Optionally, the forming the slit electrodes may include forming the slit electrodes in a region of the liquid crystal grating for forming a dark stripe or in a region of the liquid crystal grating for forming a bright stripe.

Optionally, the forming the 3D display control component may further include:

forming a plurality of electrode groups arranged in parallel to each other and spaced away from each other by a set distance, wherein each of the electrode groups includes a first strip-shaped electrode and a second strip-shaped electrode arranged in parallel to each other, having opposite polarities to each other and having a same arrangement direction as the plurality of electrode groups.

Optionally, the forming the electrode groups may include forming an electrode group in a region of the liquid crystal grating for forming a dark stripe or in a region of the liquid crystal grating for forming a bright stripe.

Optionally, the forming the liquid crystal grating on the light exit side of the display component may further include:

forming a touch detection component between the substrate and the 3D display control component or between the 3D display control component and the liquid crystal layer.

Optionally, the forming the touch detection component may include forming a touch electrode layer in a form of metal mesh structure.

The touch electrode layer manufactured by the method is a touch electrode layer in the form of metal mesh structure. On the one hand, the electrode in the touch electrode layer in the form of metal mesh structure is a metal electrode, the resistance is low, and an area occupied by the metal mesh structure is small, therefore the induction capacitance between the touch electrode and the 3D display electrode can be reduced, thereby reducing the interference; on the other hand, the cost of the metal mesh touch electrode is lower than that of indium tin oxide (ITO), therefore the production cost can be reduced.

Optionally, in order to prevent the metal touch electrode from reflecting the external light and thereby affecting the display effect, the forming the liquid crystal grating on the light exit side of the display component may further include:

forming a black matrix layer for defining pixels of all display components between the substrate and the touch electrode layer in the form of metal mesh structure.

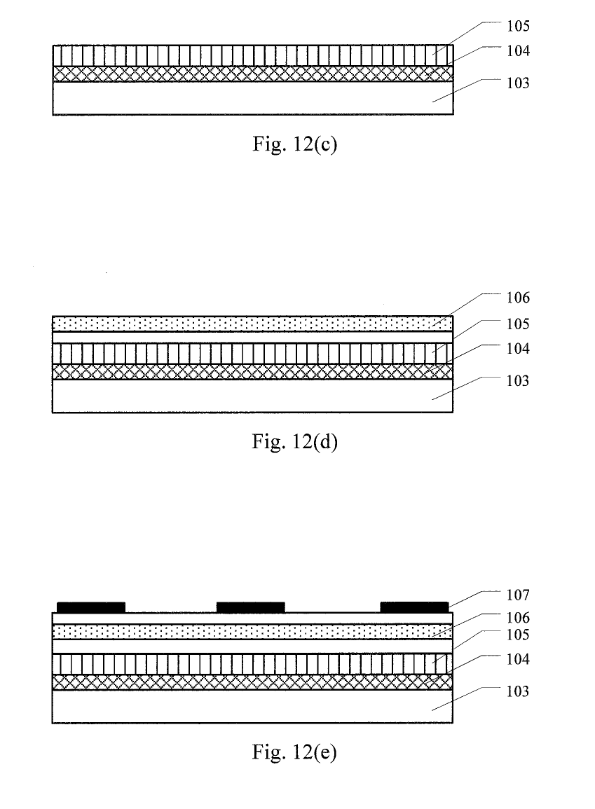

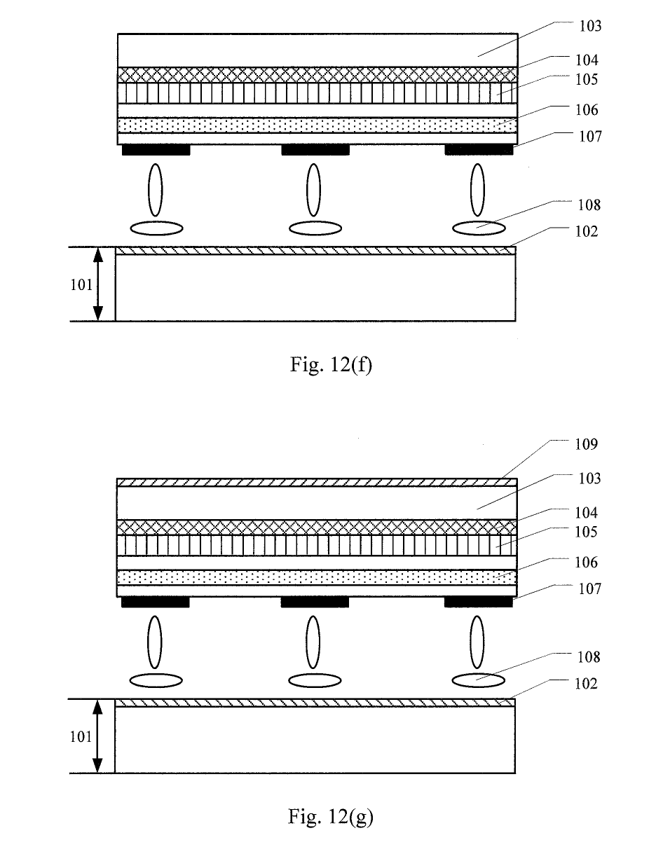

Next, taking a 3D display device in which an LCD is taken as the display component, an ADS type and normally bright type liquid crystal grating is taken as the liquid crystal grating, and the liquid crystal grating includes a touch electrode layer in the form of metal mesh structure as an example, the manufacturing process flow of the 3D display device according to the embodiments of the present disclosure will be specifically described with reference to FIG. 12(a) to FIG. 12 (g).

Step 1, referring to FIG. 12(a), forming an LCD 101 (shown by the double-headed arrow in FIG. 12(a)).

The LCD 101 includes a first polarizer 102 on a light exit side of the LCD 101.

Step 2, referring to FIG. 12 (b), forming a black matrix layer 104 for defining pixels of all LCDs on the substrate 103.

Step 3, referring to FIG. 12 (c), forming a touch electrode layer 105 in the form of metal mesh structure on the black matrix layer 104 by a metal mesh technology.

The formed touch electrode layer 105 includes a plurality of first metal electrodes extending in a first direction, a plurality of second metal electrodes extending in a second direction, and bridging portions. The bridging portions are located at an overlapping portion of the first metal electrode and the second metal electrode, such that the first metal electrode is insulated from the second metal electrode. Any two adjacent first metal electrodes and any two adjacent second metal electrodes together define a mesh cell. The first direction is not parallel to the second direction. The pixel of the LCD is disposed at a position corresponding to the mesh cell.

Step 4, referring to FIG. 12 (d), forming a common electrode 106 on the touch electrode layer 105 in the form of metal mesh structure.

The touch electrode layer 105 is insulated from the common electrode 106. For example, an insulating layer may be disposed between the touch electrode layer 105 and the common electrode 106 so that the touch electrode layer 105 is insulated from the common electrode 106.

Step 5, referring to FIG. 12(e), forming a plurality of strip-shaped slit electrodes 107 on a region on the common electrode 106 for forming a dark stripe, the slit electrodes being parallel to each other and spaced away from each other by a set distance.

The slit electrodes 107 and the common electrode 106 are insulated from each other. For example, an insulating layer may be disposed between the slit electrodes 107 and the common electrode 106 so that the slit electrodes 107 are insulated from the common electrode 106.

Step 6, referring to FIG. 12 (f), positioning the slit electrodes 107 on the substrate to face the first polarizer 102, and forming a liquid crystal layer 108 between the slit electrodes 107 and the first polarizer 102.

Step 7, referring to FIG. 12 (g), forming a second polarizer 109 on a side of the substrate 103 facing away from the liquid crystal layer 108.

In summary, in the technical solutions according to the embodiments of the present disclosure, the 3D display device includes a display component and a liquid crystal grating on a light exit side of the display component. The liquid crystal grating includes a substrate, a liquid crystal layer between the substrate and the display component, and a 3D display control component located only on a side of the substrate facing the liquid crystal layer. Since only one substrate is used for the liquid crystal grating in the 3D display device, the thickness of the 3D display device can be reduced. Moreover, the 3D display control component is located only on the side of the substrate facing the liquid crystal layer, thus when manufacturing the liquid crystal grating, the 3D display control component for achieving the 3D display function only needs to be manufactured on one substrate, therefore the manufacturing process can be simplified.

Obviously, various modifications and variations can be made to the present disclosure by those skilled in the art without departing from the spirit and scope of the present disclosure. In this way, if these modifications and variations to the present disclosure fall within the scope of the claims of the present disclosure and the equivalent thereof, the present disclosure is also intended to include these modifications and variations.

1. A 3D display device, comprising:
a display component; and
a liquid crystal grating on a light exit side of the display component,
wherein the liquid crystal grating comprises:
a substrate;
a liquid crystal layer between the substrate and the display component; and
a 3D display control component located only on a side of the substrate facing the liquid crystal layer and located only on one side of the liquid crystal layer.

2. The 3D display device according to claim 1, wherein the 3D display control component comprises:
a common electrode; and
a plurality of strip-shaped slit electrodes between the common electrode and the liquid crystal layer, the slit electrodes being parallel to each other and spaced away from each other by a set distance.

3. The 3D display device according to claim 2, wherein the plurality of slit electrodes are in regions of the liquid crystal grating for forming dark stripes; or
the plurality of slit electrodes are in regions of the liquid crystal grating for forming bright stripes.

4. The 3D display device according to claim 1, wherein the 3D display control component comprises a plurality of electrode groups arranged in parallel to each other and spaced away from each other by a set distance,
wherein each of the electrode groups comprises a first strip-shaped electrode and a second strip-shaped electrode arranged in parallel to each other, having opposite polarities to each other and having a same arrangement direction as the plurality of electrode groups.

5. The 3D display device according to claim 4, wherein the electrode groups are in regions of the liquid crystal grating for forming dark stripes; or
the electrode groups are in regions of the liquid crystal grating for forming bright stripes.

6. The 3D display device according to claim 1, wherein the liquid crystal grating further comprises a touch detection component between the substrate and the 3D display control component or between the 3D display control component and the liquid crystal layer.

7. The 3D display device according to claim 6, wherein the touch detection component comprises a touch electrode layer in a form of metal mesh structure.

8. A method for manufacturing a 3D display device, comprising:
forming a display component; and
forming a liquid crystal grating on a light exit side of the display component,
wherein the forming the liquid crystal grating on the light exit side of the display component comprises:
forming a 3D display control component only on a substrate; and
positioning the 3D display control component to face the light exit side of the display component, and forming a liquid crystal layer between the substrate on which the 3D display control component is formed and the display component in such a way that the 3D display control component is located only on one side of the liquid crystal layer.

9. The method according to claim 8, wherein the forming the 3D display control component comprises:
forming a common electrode; and
forming a plurality of strip-shaped slit electrodes on the common electrode, the slit electrodes being parallel to each other and spaced away from each other by a set distance.

10. The method according to claim 9, wherein the forming the slit electrodes comprises forming the slit electrodes in regions of the liquid crystal grating for forming dark stripes or in regions of the liquid crystal grating for forming bright stripes.

11. The method according to claim 8, wherein the forming the 3D display control component comprises:
forming a plurality of electrode groups arranged in parallel to each other and spaced away from each other by a set distance,
wherein each of the electrode groups comprises a first strip-shaped electrode and a second strip-shaped electrode arranged in parallel to each other, having opposite polarities to each other and having a same arrangement direction as the plurality of electrode groups.

12. The method according to claim 11, wherein the forming the electrode groups comprises forming electrode groups in regions of the liquid crystal grating for forming dark stripes or in regions of the liquid crystal grating for forming bright stripes.

13. The method according to claim 8, wherein the forming the liquid crystal grating on the light exit side of the display component further comprises:
forming a touch detection component between the substrate and the 3D display control component or between the 3D display control component and the liquid crystal layer.

14. The method according to claim 13, wherein the forming the touch detection component comprises forming a touch electrode layer in a form of metal mesh structure.

15. The 3D display device according to claim 1, wherein the liquid crystal grating comprises only one substrate.

16. The 3D display device according to claim 1, wherein the display component comprises a first polarizer on the light exit side of the display component, and the liquid crystal grating comprises a second polarizer on a side of the substrate facing away from the liquid crystal layer.

17. The 3D display device according to claim 7, wherein the touch electrode layer comprises:
a plurality of first metal electrodes extending in a first direction;
a plurality of second metal electrodes extending in a second direction; and
bridging portions located at overlapping portions of the first metal electrodes and the second metal electrodes in such a way that the first metal electrodes are insulated from the second metal electrodes.

18. The 3D display device according to claim 2, wherein the liquid crystal grating further comprises a touch detection component between the substrate and the 3D display control component or between the 3D display control component and the liquid crystal layer.

19. The 3D display device according to claim 18, wherein the touch detection component comprises a touch electrode layer in a form of metal mesh structure.

20. The 3D display device according to claim 19, wherein the touch electrode layer comprises:
a plurality of first metal electrodes extending in a first direction;
a plurality of second metal electrodes extending in a second direction; and
bridging portions located at overlapping portions of the first metal electrodes and the second metal electrodes in such a way that the first metal electrodes are insulated from the second metal electrodes.
